(19) United States
(12) Patent Application Publication
(10) Pub. No.: US 2026/0112533 A1
(43) Pub. Date: Apr. 23, 2026

(54) COIL ELECTRONIC COMPONENT

(71) Applicant: SAMSUNG ELECTRO-MECHANICS CO., LTD., Suwon-si (KR)

(72) Inventors: Sangjin Kim, Suwon-si (KR); Han Lee, Suwon-si (KR); Jongwook Lee, Suwon-si (KR); Boumseock Kim, Suwon-si (KR); Joongwon Park, Suwon-si (KR)

(73) Assignee: SAMSUNG ELECTRO-MECHANICS CO., LTD., Suwon-si (KR)

(21) Appl. No.: 19/084,132

(22) Filed: Mar. 19, 2025

(30) Foreign Application Priority Data
Oct. 21, 2024 (KR) 10-2024-0144040

(51) Int. Cl. H01F 27/28; H01F 27/30; H01F 27/32

(52) U.S. Cl. CPC H01F 27/2823; H01F 27/306; H01F 27/327

(57) ABSTRACT

A coil electronic component may include: a body including a first surface and a second surface opposing each other in a first direction, a third surface and a fourth surface opposing each other in a second direction and connecting the first surface and the second surface, and a fifth surface and a sixth surface opposing each other in a third direction and connecting the first surface and the second surface, and including a magnetic material; three or more coils embedded in the body; and a first insulating layer and a second insulating layer disposed on the first surface and the second surface of the body, respectively, or on the fifth surface and the sixth surface of the body, respectively. A sum of a thickness of the first insulating layer and a thickness of the second insulating layer may be 90 μm or more and 120 μm or less.

### CROSS-REFERENCE TO RELATED APPLICATION

This application claims priority to and the benefit of Korean Patent Application No. 10-2024-0144040 filed in the Korean Intellectual Property Office on Oct. 21, 2024, the entire contents of which are incorporated herein by reference.

### BACKGROUND

### 1. Field

The present disclosure relates to a coil electronic component.

### 2. Description of the Related Art

An inductor, a type of coil electronic component, is a representative passive element configuring an electronic circuit, together with a resistor and a capacitor, to remove noise, and is combined with such a capacitor using electromagnetism to provide a resonance circuit amplifying a signal in a specific frequency band, a filter circuit, or the like.

In addition, power consumption is increasing as miniaturization and high performance of electronic devices are required. Due to this increase in power consumption, the switching frequency of power management integrated circuit (PMIC) or DC-DC converter used in the power circuit of electronic devices is becoming higher, the output current is increasing, and the use of power inductors used to stabilize the output current of PMIC or DC-DC converter is increasing.

Demand for an array-type inductor having the advantage of reducing a mounting area is also increasing. Array-type inductors include a plurality of coils and a plurality of external electrodes connected to the coils, and it is necessary to secure sufficient insulation resistance between the external electrodes.

### SUMMARY

One aspect of an embodiment attempts to provide a coil electronic component having a high switching frequency.

Another aspect of an embodiment attempts to provide a coil electronic component with sufficient insulation resistance.

However, the problems to be solved by the embodiments are not limited to the above-mentioned problems, but can be variously extended within the scope of the technical spirit included in the embodiments.

An embodiment of the present disclosure provides a coil electronic component which may include: a body including a first surface and a second surface opposing each other in a firs direction, a third surface and a fourth surface opposing each other in a second direction and connecting the first surface and the second surface, and a fifth surface and a sixth surface opposing each other in a third direction and connecting the first surface and the second surface, and including a magnetic material; three or more coils embedded in the body; and a first insulating layer and a second insulating layer disposed on the first surface and the second surface of the body, respectively, or on the fifth surface and the sixth surface of the body, respectively. A sum of a thickness of the first insulating layer and a thickness of the second insulating layer may be 90 μm or more and 120 μm or less.

The first insulating layer and the second insulating layer may each include a magnetic material.

The magnetic material included in the first insulating layer and the magnetic material included in the second insulating layer may be different from the magnetic material included in the body.

A magnetic permeability of the first insulating layer may be larger than a magnetic permeability of the body, and a magnetic permeability of the second insulating layer may be larger than the magnetic permeability of the body.

The coil electronic component may further include a first support member, a second support member, and a third support member that are embedded in the body and spaced apart from each other, and the coils may include a first coil, a second coil, and a third coil that are spaced apart from each other, the first coil may be disposed on the first support member, the second coil may be disposed on the second support member, and the third coil may be disposed on the third support member.

A winding axis of each of the first coil, the second coil, and the third coil may be parallel to the third direction, the first insulating layer may be disposed on the fifth surface of the body, and the second insulating layer may be disposed on the sixth surface of the body.

A winding axis of each of the first coil, the second coil, and the third coil may be parallel to the first direction, the first insulating layer may be disposed on the fifth surface of the body, and the second insulating layer may be disposed on the sixth surface of the body.

A winding axis of each of the first coil, the second coil, and the third coil may be parallel to the first direction, the first insulating layer may be disposed on the first surface of the body, and the second insulating layer may be disposed on the second surface of the body.

The first coil may include two coil patterns disposed on one surface and the other surface of the first support member, respectively, and connected to each other through a via penetrating the first support member, the second coil may include two coil patterns disposed on one surface and the other surface of the second support member, respectively, and connected to each other through a via penetrating the second support member, and the third coil may include two coil patterns disposed on one surface and the other surface of the second support member, respectively, and connected to each other through a via penetrating the third support member.

The body may be a laminate in which a plurality of magnetic sheets is stacked, the coils may include a first coil, a second coil, and a third coil that are spaced apart from each other, and each of the first coil, the second coil, and the third coil may include a plurality of conductive patterns disposed on each magnetic sheet of the plurality of magnetic sheets, and connected to each other.

The coils may include a first coil, a second coil, and a third coil that are spaced apart from each other, and each of the first coil, the second coil, and the third coil may include at least one turn of a conductive wire.

The body may include a first core penetrating the first coil, a second core penetrating the second coil, and a third core penetrating the third coil.

An insulating film may be disposed on the surface of the conductive wire.

The coil electronic component may further include three or more pairs of external electrodes connected to the three or more coils, respectively. Each of the three or more pairs of external electrodes may include one external electrode disposed on the third surface and another external electrode disposed on the fourth surface.

The first insulating layer and the second insulating layer may be disposed only on surfaces selected from the first, second, fifth, and sixth surfaces among the first to sixth surfaces of the body.

The first insulating layer and the second insulating layer may be disposed only on the first surface and the second surface of the body, respectively, or only on the fifth surface and the sixth surface of the body, respectively.

According to an embodiment, a coil electronic component having a high switching frequency can be provided.

Further, according to an embodiment, a coil electronic component having secured sufficient insulation resistance can be provided.

### BRIEF DESCRIPTION OF THE DRAWINGS

FIG. 1 is a perspective view schematically illustrating a coil electronic component according to an embodiment.

FIG. 2 is a plan view of FIG. 1.

FIG. 3 is a schematic cross-sectional view taken along line I-I′ of FIG. 1.

FIG. 4 is a perspective view schematically illustrating a coil electronic component according to another embodiment.

FIG. 5 is a perspective view schematically illustrating a coil electronic component according to yet another embodiment.

FIG. 6 is a perspective view schematically illustrating a coil electronic component according to still yet another embodiment.

FIG. 7 is a plan view of FIG. 6.

FIG. 8 is an exploded perspective view illustrating a body of the coil electronic component of FIG. 6.

FIG. 9 is a perspective view schematically illustrating a coil electronic component according to another embodiment.

FIG. 10 is a schematic cross-sectional view taken along line II-II′ of FIG. 9.

### DETAILED DESCRIPTION

Hereinafter, embodiments of the present disclosure will be described in detail so as to be easily implemented by those skilled in the art, with reference to the accompanying drawings. The drawings and description are to be regarded as illustrative in nature and not restrictive. Like reference numerals designate like elements throughout the specification. In addition, some components are exaggerated or omitted or schematically illustrated in the accompanying drawings, and the size of each component is not fully reflected in the actual size.

It is to be understood that the accompanying drawings are just used for easily understanding the embodiments disclosed in this specification and a technical spirit disclosed in this specification is not limited by the accompanying drawings and all changes, equivalents, or substitutes included in the spirit and the technical scope of the present disclosure are included.

Terms including an ordinary number, such as first and second, are used for describing various components, but the components are not limited by the terms. The terms are used only to discriminate one constituent element from another component.

Further, it will be understood that when an element such as a layer, film, region, or substrate is referred to as being “on” another element, it can be directly on the other element or intervening elements may also be present. In contrast, when an element is referred to as being “directly on” another element, there are no intervening elements present. In addition, to be referred to as “on” or “on” a reference portion is located above or below the reference portion, and does not particularly mean to “above” or “on” the direction opposite to gravity.

Throughout the specification, it should be understood that the term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance. Accordingly, unless explicitly described to the contrary, the word “comprise”, and variations such as “comprises” or “comprising”, will be understood to imply the inclusion of stated elements but not the exclusion of any other elements.

Further, throughout the specification, “plan view” means that a target part is viewed from the top, and “cross-sectional view” means that a cross section vertically cutting the target part is viewed from the side.

In addition, throughout the specification, the term “connected” does not mean that two or more components are directly connected, but may mean being indirectly connected to the two or more components through other components, and electrically connected, or may be referred to as different names according to a location or function, but may be integrated.

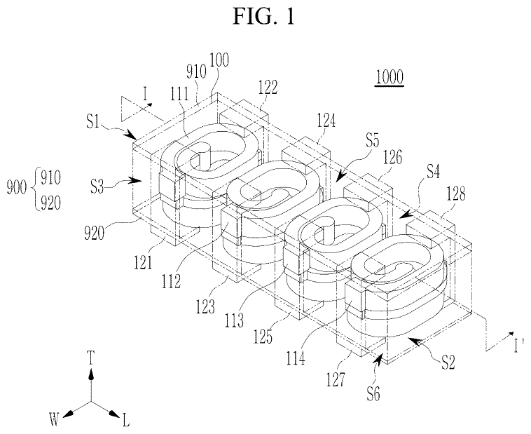

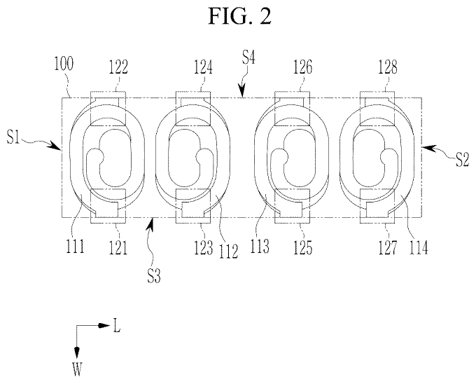

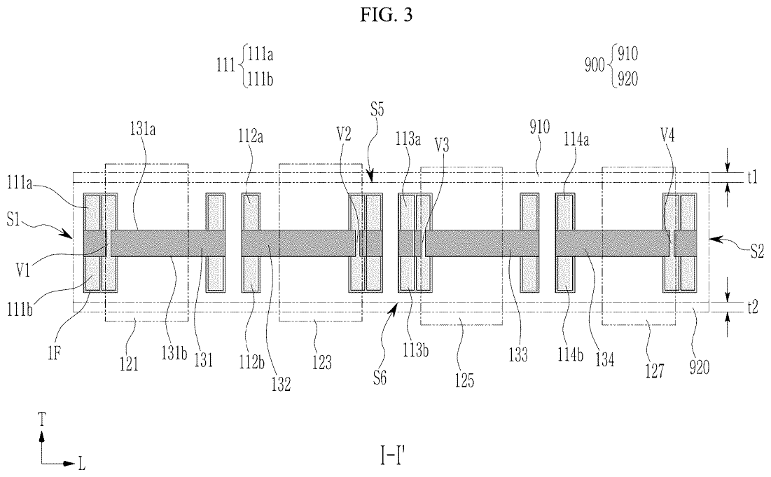

FIG. 1 is a perspective view schematically illustrating a coil electronic component according to an embodiment, FIG. 2 is a plan view of FIG. 1, and FIG. 3 is a schematic cross-sectional view taken along line I-I′ of FIG. 1.

Referring to FIGS. 1, 2, and 3, the coil electronic component 1000 according to an embodiment corresponds to an array-type inductor that includes a plurality of coils 111, 112, 113, and 114 spaced apart from each other.

The coil electronic component 1000 includes first to fourth coils 111, 112, 113, and 114, but the embodiment is not limited thereto. For example, a coil electronic component that includes three coils or a coil electronic component that includes more than four coils may be provided, if needed.

The coil electronic component 1000 includes a body 100, a plurality of external electrodes 121, 122, 123, 124, 125, 126, 127, and 128 disposed on an outer surface of the body 100, and a surface insulating layer 900.

The body 100 may have a substantially rectangular hexahedral shape, but the present embodiment is not limited thereto. Due to shrinkage of magnetic powder or the like during sintering, the body 100 may not have a perfect rectangular hexahedral shape, but may have a substantially rectangular hexahedral shape. For example, the body 100 has a substantially rectangular hexahedral shape, but corner or vertex portions may have a rounded shape.

In the present embodiment, for convenience of description, two surfaces opposing each other in the length direction (L-axis direction) will be defined as a first surface S1 and a second surface S2, two surfaces opposing each other in the width direction (W-axis direction) of the coil electronic component 1000 will be defined as a third surface S3 and a fourth surface S4, and two surfaces opposing each other in the thickness direction (T-axis direction) of the coil electronic component 1000 will be defined as a fifth surface S5 and a sixth surface S6.

A length of the coil electronic component 1000 may mean, based on an optical microscope or scanning electron microscope (SEM) photograph of a cross-section in the length direction (L-axis direction)-the thickness direction (T-axis direction) at a center of the coil electronic component 1000 in the width direction (W-axis direction), a maximum value of lengths of a plurality of line segments that connect two outermost boundary lines facing each other in the length direction (L-axis direction) of the coil electronic component 1000 shown in the above cross-sectional photograph and are parallel to the length direction (L-axis direction). Alternatively, the length of the coil electronic component 1000 may mean a minimum value of lengths of a plurality of line segments that connect two outermost boundary lines facing each other in the length direction (L-axis direction) of the coil electronic component 1000 shown in the above cross-sectional photograph and are parallel to the length direction (L-axis direction). Alternatively, the length of the coil electronic component 1000 may mean an arithmetic average value of lengths of at least two of a plurality of line segments that connect two outermost boundary lines facing each other in the length direction (L-axis direction) of the coil electronic component 1000 shown in the above cross-sectional photograph and are parallel to the length direction (L-axis direction).

A thickness of the coil electronic component 1000 may mean, based on an optical microscope or scanning electron microscope (SEM) photograph of a cross-section in the length direction (L-axis direction)-the thickness direction (T-axis direction) at a center of the coil electronic component 1000 in the width direction (W-axis direction), a maximum value of lengths of a plurality of line segments that connect two outermost boundary lines facing each other in the thickness direction (T-axis direction) of the coil electronic component 1000 shown in the above cross-sectional photograph and are parallel to the thickness direction (T-axis direction). Alternatively, the thickness of the coil electronic component 1000 may mean a minimum value of lengths of a plurality of line segments that connect two outermost boundary lines facing each other in the thickness direction (T-axis direction) of the coil electronic component 1000 shown in the above cross-sectional photograph and are parallel to the thickness direction (T-axis direction). Alternatively, the thickness of the coil electronic component 1000 may mean an arithmetic average value of lengths of at least two of a plurality of line segments that connect two outermost boundary lines facing each other in the thickness direction (T-axis direction) of the coil electronic component 1000 shown in the above cross-sectional photograph and are parallel to the thickness direction (T-axis direction).

A width of the coil electronic component 1000 may mean, based on an optical microscope or scanning electron microscope (SEM) photograph of a cross-section in the length direction (L-axis direction)-the width direction (W-axis direction) at a center of the coil electronic component 1000 in the thickness direction (T-axis direction), a maximum value of lengths of a plurality of line segments that connect two outermost boundary lines facing each other in the width direction (W-axis direction) of the coil electronic component 1000 shown in the above cross-sectional photograph and are parallel to the width direction (W-axis direction). Alternatively, the width of the coil electronic component 1000 may mean a minimum value of lengths of a plurality of line segments that connect two outermost boundary lines facing each other in the width direction (W-axis direction) of the coil electronic component 1000 shown in the above cross-sectional photograph and are parallel to the width direction (W-axis direction). Alternatively, the width of the coil electronic component 1000 may mean an arithmetic average value of lengths of at least two of a plurality of line segments that connect two outermost boundary lines facing each other in the width direction (W-axis direction) of the coil electronic component 1000 shown in the above cross-sectional photograph and are parallel to the width direction (W-axis direction).

Each of the length, the width, and the thickness of the coil electronic component 1000 may be measured by a micrometer measurement method. In the micrometer measurement method, a zero point is set with a micrometer providing repeatability and reproducibility (Gage R&R), the coil electronic component 1000 according to the present embodiment is inserted between tips of the micrometer, and a measuring lever of the micrometer is turned for the measurement. When measuring the length of the coil electronic component 1000 by the micrometer measurement method, the length of the coil electronic component 1000 may mean a value measured once or mean an arithmetic average of values measured a plurality of times. This may be equally applied to measuring the width and thickness of the coil electronic component 1000.

The body 100 includes a plurality of coils 111, 112, 113, and 114 spaced apart from each other in the length direction (L-axis direction) therein. The plurality of coils preferably may have substantially the same shape. Here, the disclosure that the plurality of coils has the same shape means that the line width, thickness, and number of windings of coil patterns of each coil are substantially the same. In FIGS. 1 to 3, the number of windings of the coil is represented by about 1.5 turns for convenience of description, but the present embodiment is not limited thereto, and may be appropriately selected by a person skilled in the art in consideration of electrical characteristics such as required inductance and direct current resistance (Rdc).

The body 100 constitutes an exterior of the coil electronic component 1000, and is a space where a magnetic path, which is a path through which a magnetic flux generated by the first to fourth coils 111, 112, 113, and 114 passes, is formed, when a current is applied to the first to fourth coils 111, 112, 113, and 114 through a plurality of external electrodes 121, 122, 123, 124, 125, 126, 127, and 128.

The body 100 surrounds and encapsulates the first to fourth coils 111, 112, 113, and 114, and first to fourth support members 131, 132, 133, and 134, and includes a magnetic material. The body 100 may include magnetic particles, and an insulating material may be interposed between the magnetic particles.

The magnetic material may include first metal magnetic particles, second metal magnetic particles having a smaller size than the first metal magnetic particles, and third metal magnetic particles having a smaller particle size than the second metal magnetic particles. An average particle diameter D₅₀ of the first metal magnetic particles may be 5 μm or more 30 μm or less, an average particle diameter D₅₀ of the second metal magnetic particles may be 1 μm or 5 μm or less, and an average particle diameter D₅₀ of the third metal magnetic particles may be 0.05 μm or 0.5 μm or less

The magnetic particle may be a ferrite particle or a metal magnetic particle exhibiting magnetic characteristics.

The ferrite particles may include, for example, at least one of spinel-type ferrites such as Mg—Zn-based, Mn—Zn-based, Mn—Mg-based, Cu—Zn-based, Mg—Mn—Sr-based, Ni—Zn-based ferrites, hexagonal ferrites such as Ba—Zn-based, Ba—Mg-based, Ba—Ni-based, Ba—Co-based, Ba—Ni—Co-based ferrites, garnet-type ferrites such as Y-based ferrites and Li-based ferrites.

The metal magnetic particles may be composed of two or more types of powders having different compositions, and may include at least one selected from the group consisting of iron (Fe), silicon (Si), chromium (Cr), cobalt (Co), molybdenum (Mo), aluminum (Al), niobium (Nb), copper (Cu), and nickel (Ni). For example, metal magnetic particles may be at least one of pure iron, Fe—Si-based alloy, Fe—Si—Al-based alloy, Fe—Ni-based alloy, Fe—Ni—Mo-based alloy, Fe—Ni—Mo—Cu-based alloy, Fe—Co-based alloy, Fe—Ni—Co-based alloy, Fe—Cr-based alloy, Fe—Cr—Si-based alloy, Fe—Si—Cu—Nb-based alloy, Fe—Ni—Cr-based alloy, and Fe—Cr—Al-based alloy. Here, different compositions of the metal magnetic particles may mean different contents.

The metal magnetic particle may be amorphous or crystalline. For example, the metal magnetic particle may be an Fe—Si—B—Cr-based amorphous alloy, but the embodiment is not limited thereto. The metal magnetic particle may have an average particle diameter in a range from about 0.1 to about 30 μm, but the embodiment is not limited thereto

In the present specification, the average particle diameter may mean a particle size distribution expressed by D₉₀, D₅₀, or the like. The particle size distribution is well known to those skilled in the art as an index indicating what size (particle diameter) particles are included in what proportion in a particle group to be measured. D₅₀ (a particle diameter corresponding to 50% of a cumulative volume of the particle size distribution) refers to an average particle diameter.

The metal magnetic particle may be two or more types of different metal magnetic particles. Here, by different types of metal magnetic particles, it is meant that the metal magnetic particles are distinguished from each other in at least one of an average particle diameter, composition, component ratio, crystallinity, and shape.

The insulating material may include epoxy, polyimide, liquid crystal polymer, etc., alone or in combination, but the embodiment is not limited thereto.

The coils 111, 112, 113, and 114 are embedded in the body 100 and exhibits the characteristics of the coil electronic component 1000. For example, when the coil electronic component 1000 according to the present embodiment is used as a power inductor, when a current is applied to the coils 111, 112, 113, and 114, the coils may serve to stabilize the power supply of an electronic device by storing energy in the form of a magnetic field maintain an output voltage.

Starting from the first coil 111 closest to the first surface S1 of the body 100, the second coil 112, the third coil 113, and the fourth coil 114 are sequentially disposed in the length direction (L-axis direction). Accordingly, the fourth coil 114 is disposed closest to the second surface S2 of the body 100, and the second coil 112 and the third coil 113 are disposed between the first coil 111 and the fourth coil 114.

The respective winding axes of the first coil 111, the second coil 112, the third coil 113, and the fourth coil 114 may be parallel to the thickness direction (T-axis direction) of the body 100.

The first coil 111 is connected to the first external electrode 121 and the second external electrode 122, which are disposed to be spaced apart from each other in the width direction (W-axis direction) of the body 100, and the second coil 112 is connected to the third external electrode 123 and the fourth external electrode 124, which are disposed to be spaced apart from each other in the width direction (W-axis direction) of the body 100.

The third coil 113 is connected to the fifth external electrode 125 and the sixth external electrode 126, which are disposed to be spaced apart from each other in the width direction (W-axis direction) of the body 100, and the fourth coil 114 is connected to the seventh external electrode 127 and the eighth external electrode 128, which are disposed to be spaced apart from each other in the width direction (W-axis direction) of the body 100.

The first to eighth external electrodes 121, 122, 123, 124, 125, 126, 127, and 128 extend from the third surface S3 or the fourth surface S4 of the body 100 to cover a portion of the fifth surface S5 and a portion of the sixth surface S6, but the embodiment is not limited thereto. For example, the first to eighth external electrodes 121, 122, 123, 124, 125, 126, 127, and 128 may be disposed only on the third surface S3 or the fourth surface S4 of the body 100, or may extend from the third surface S3 or the fourth surface S4 to cover only a portion of the sixth surface S6.

For example, the first to eighth external electrodes 121, 122, 123, 124, 125, 126, 127, and 128 may include a conductive material such as copper (Cu), aluminum (Al), silver (Ag), tin (Sn), gold (Au), nickel (Ni), lead (Pb), chrome (Cr), titanium (Ti), or alloys thereof, but the embodiment is not limited thereto.

As another example, the first to eighth external electrodes 121, 122, 123, 124, 125, 126, 127, and 128 may include a conductive metal and glass. The conductive metal may be, for example, a conductive metal including copper (Cu), nickel (Ni), tin (Sn), palladium (Pd), platinum (Pt), gold (Au), silver (Ag), tungsten (W), titanium (Ti), lead (Pb) alone, or alloys thereof. The glass component included in the external electrode may be a mixture of oxides. The glass component may include, for example, a silicon oxide, a boron oxide, an aluminum oxide, a transition metal oxide, an alkaline metal oxide, an alkaline-earth metal oxide, or combinations thereof. Here, the transition metal may be selected from zinc (Zn), titanium (Ti), copper (Cu), vanadium (V), manganese (Mn), iron (Fe), or nickel (Ni), the alkaline metal may be selected from lithium (Li), sodium (Na), or potassium (K), and the alkaline-earth metal may be selected from magnesium (Mg), calcium (Ca), strontium (Sr), or barium (Ba). The method of forming the external electrodes may not be particularly limited. For example, it may be formed by dipping a body in a conductive paste containing a conductive metal and glass, or by printing a conductive paste on the surface of the body by, e.g., screen printing or gravure printing method. In addition, various methods, such as applying a conductive paste on the surface of a body or transferring a dry film formed by drying a conductive paste to a body, may be used.

Referring to FIG. 3, the first coil 111 is disposed on the first support member 131. The first coil 111 includes an upper coil 111a disposed on an upper surface 131a of the first support member 131 and a lower coil 111b disposed on a lower surface 131b of the first support member 131. The upper coil 111a and the lower coil 111b are connected to each other through a first via V1 penetrating the first support member 131.

The first support member 131 may be made of an insulating material including a thermosetting insulating resin such as an epoxy resin, a thermoplastic insulating resin such as polyimide, or a photosensitive insulating resin, or may be formed by impregnating a reinforcing material such as glass fiber or inorganic filler in the insulating resin. For example, the support member may be made of an insulating material such as Prepreg, ABF (Ajinomoto Build-up Film), FR-4, BT (Bismaleimide Triazine) film, or PID (Photo Imageable Dielectric) film, but the embodiment is not limited thereto.

At least one selected from the group consisting of silica (SiO₂), alumina (Al₂O₃), silicon carbide (SiC), barium sulfate (BaSO₄), talc, clay, mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃) may be used as the inorganic filler.

Each of the first coil 111 and the first via V1 may be made of a conductive material such as copper (Cu), aluminum (Al), silver (Ag), tin (Sn), gold (Au), nickel (Ni), lead (Pb), titanium (Ti), or an alloy thereof, but the embodiment is not limited thereto.

An insulating film IF may be disposed between the first coil 111 and the body 100. The insulating film IF may be formed along the surface of the first support member 131 and the surface of the first coil 111. The insulating film IF does not exist in a portion where the first support member 131 and the first coil 111 are connected to the first external electrode 121 and the second external electrode 122. The insulating film IF is for insulating the first coil 111 from the body 100 and may include a known insulating material such as parylene, etc. Any insulating material may be used in the insulating film IF, and there is no particular limitation. For example, the insulating layer IF may be a polyurethane resin, a polyester resin, an epoxy resin, or a polyamideimide resin. The insulating film IF may be formed by a method such as vapor deposition, but is not limited thereto. For example, the insulating film IF may be formed by stacking insulating films on both surfaces of the first support member 131.

The second coil 112, the third coil 113, and the fourth coil 114 differ from the first coil 111 only in their locations, so redundant descriptions thereof will be omitted.

The surface insulating layer 900 may be disposed on the fifth surface S5 and the sixth surface S6 of the body 100.

The surface insulating layer 900 may partially cover the fifth surface S5 and the sixth surface S6 of the body 100. That is, the first to eighth external electrodes 121, 122, 123, 124, 125, 126, 127, and 128 may be disposed on the fifth surface S5 and the sixth surface S6 of the body 100, and the surface insulating layer 900 may not cover the first to eighth external electrodes 121, 122, 123, 124, 125, 126, 127, and 128.

The surface insulating layer 900 may prevent leakage current between the first to eighth external electrodes 121, 122, 123, 124, 125, 126, 127, and 128.

The surface insulating layer 900 may include a magnetic material. That is, the surface insulating layer 900 may include magnetic particles, and an insulating material may be interposed between the magnetic particles.

A magnetic permeability of the surface insulating layer 900 may be greater than a magnetic permeability of the body 100. For example, the magnetic permeability of the body 100 may be 12 H/m, and the magnetic permeability of the surface insulating layer 900 may be 24 H/m. In this case, the surface insulating layer 900 may be made of a different material from the body 100. A composition of materials forming the surface insulating layer 900 and a composition of materials forming the body 100 may be inferred from a scanning electron microscope (SEM) photograph of the coil electronic component.

For example, as a method of adjusting the magnetic permeability of the surface insulating layer 900 and the body 100, a volume fraction of the first magnetic particles included in the first insulating layer 900 and a volume fraction of the second magnetic particles included in the body 100 may be set differently. Here, the volume fraction of the magnetic particles refers to a ratio of the volume of the first magnetic particles to the volume of the surface insulating layer 900 or a ratio of the volume of the second magnetic particles to the volume of the body 100. In order to adjust relative permeabilities of the surface insulating layer 900 and the body 100 based on the volume fractions of the first magnetic particles and the second magnetic particles, the first magnetic particles and the second magnetic particles may be realized as the same material, for example, a metal alloy of the same composition. Meanwhile, as a method for adjusting the magnetic permeabilities of the surface insulating layer 900 and the body 100, an area fraction of the first magnetic particles included in the first insulating layer 900 and an area fraction of the second magnetic particles included in the body 100 may be set differently when confirmed in cross-section. Here, the area fraction of the magnetic particles refers to a ratio of a cross-sectional area of the first magnetic particles to a cross-sectional area of the surface insulating layer 900 or a ratio of the cross-sectional area of the second magnetic particles to the cross-sectional area of the body 100.

When the magnetic permeability of the body 100 is smaller than the magnetic permeability of the surface insulating layer 900, the volume fraction of the second magnetic particles included in the body 100 is smaller than the volume fraction of the first magnetic particles included in the surface insulating layer 900. If the magnetic permeability of the body 100 is smaller than the magnetic permeability of the surface insulating layer 900, the coefficient of coupling of the first coil 111, the second coil 112, the third coil 113, and the fourth coil 114 may relatively increase. Here, a relative increase in the coefficient of coupling means that the coefficient of coupling become larger compared with the case where the magnetic permeability of the body 100 and the magnetic permeability of the surface insulating layer 900 are the same. When the magnetic permeability of the body 100 is relatively small, an amount of magnetic flux flowing through the body 100 is relatively small, and a mutual inductance caused by a magnetic flux shared by the first coil 111, the second coil 112, the third coil 113, and the fourth coil 114 becomes larger. Here, the magnetic flux flowing through the body 100 may be understood as magnetic flux flowing through the body 100 in the length direction (L-axis direction) in FIG. 3.

The surface insulating layer 900 includes a first insulating layer 910 and a second insulating layer 920. The first insulating layer 910 is disposed on the fifth surface S5 of the body 100, and the second insulating layer 920 is disposed on the sixth surface S6 of the body 100.

A sum of a thickness t1 of the first insulating layer 910 and a thickness t2 of the second insulating layer 920 may be 90 μm or more and 120 μm or less.

If the sum of the thickness t1 of the first insulating layer 910 and the thickness t2 of the second insulating layer 920 is less than 90 μm, the insulating layers are too thin to secure sufficient insulation resistance (IR).

If the sum of the thickness t1 of the first insulating layer 910 and the thickness t2 of the second insulating layer 920 is more than 120 μm, the self-inductance of the coil may be increased due to the effect of the relatively large magnetic permeability, resulting in a large increase in the inductance. Furthermore, large magnetic permeability may mean that particles are large, which may cause the switching frequency to be too small due to eddy current losses.

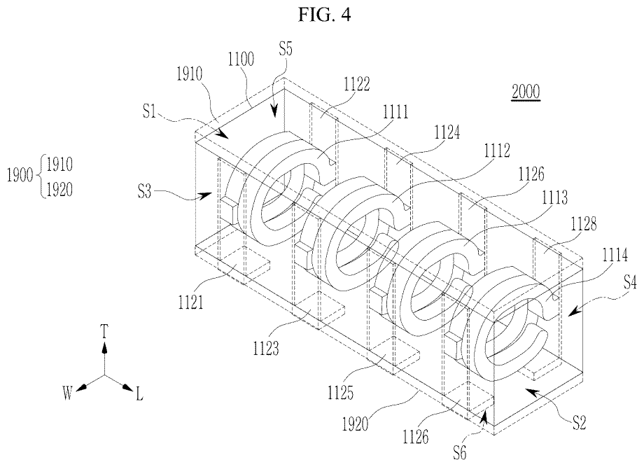

FIG. 4 is a perspective view schematically illustrating a coil electronic component according to another embodiment.

Referring to FIG. 4, the coil electronic component 2000 includes a body 1100, and first to eighth external electrodes 1121, 1122, 1123, 1124, 1125, 1126, 1127, and 1128 disposed on an outer surface of the body 1100.

While the first to eighth external electrodes 1121, 1122, 1123, 1124, 1125, 1126, 1127, and 1128 are shown extending from the third surface S3 or the fourth surface S4 of the body 1100 and covering a portion of the sixth surface S6, the embodiment is not limited thereto. For example, the first to eighth external electrodes 1121, 1122, 1123, 1124, 1125, 1126, 1127, and 1128 may be disposed only on the third surface S3 or the fourth surface S4 of the body 100, or may extend from the third surface S3 or the fourth surface S4 to cover a portion of the fifth surface S5 and a portion of the sixth surface S6.

A first coil 1111, a second coil 1112, a third coil 1113, and a fourth coil 1114 are embedded in the body 1100. The respective winding axes of the first coil 1111, the second coil 1112, the third coil 1113, and the fourth coil 1114 may be parallel to the length direction (L-axis direction) of the body 1100.

A surface insulating layer 1900 is disposed on the fifth surface S5 and the sixth surface S6 of the body 1100.

The surface insulating layer 1900 includes a first insulating layer 1910 and a second insulating layer 1920. The first insulating layer 1910 is disposed on the fifth surface S5 of the body 1100, and the second insulating layer 1920 is disposed on the sixth surface S6 of the body 1100.

A sum of a thickness of the first insulating layer 1910 and a thickness of the second insulating layer 1920 may be 90 μm or more and 120 μm or less.

The remaining components except the above are the same as the components of the coil electronic components shown in FIG. 1, so a repeated description thereof will be omitted.

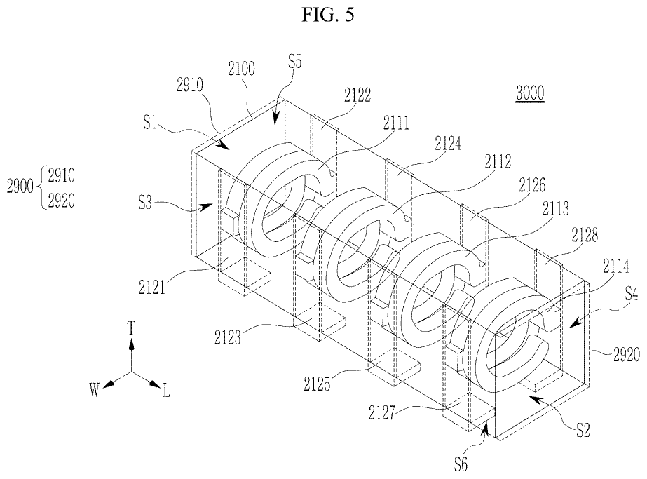

FIG. 5 is a perspective view schematically illustrating a coil electronic component according to yet another embodiment.

Referring to FIG. 5, the coil electronic component 3000 includes a body 2100, and first to eighth external electrodes 2121, 2122, 2123, 2124, 2125, 2126, 2127, and 2128 disposed on an outer surface of the body 2100.

A first coil 2111, a second coil 2112, a third coil 2113, and a fourth coil 2114 are embedded in the body 2100. The respective winding axes of the first coil 2111, the second coil 2112, the third coil 2113, and the fourth coil 2114 may be parallel to the length direction (L-axis direction) of the body 2100.

A surface insulating layer 2900 is disposed on the first surface S1 and the second surface S2 of the body 2100.

The surface insulating layer 2900 includes a first insulating layer 2910 and a second insulating layer 2920. The first insulating layer 2910 is disposed on the first surface S1 of the body 2100, and the second insulating layer 2920 is disposed on the second surface S2 of the body 2100.

A sum of a thickness of the first insulating layer 2910 and a thickness of the second insulating layer 2920 may be 90 μm or more and 120 μm or less.

The remaining components except the above are the same as the components of the coil electronic components shown in FIGS. 1 and 4, so a repeated description thereof will be omitted.

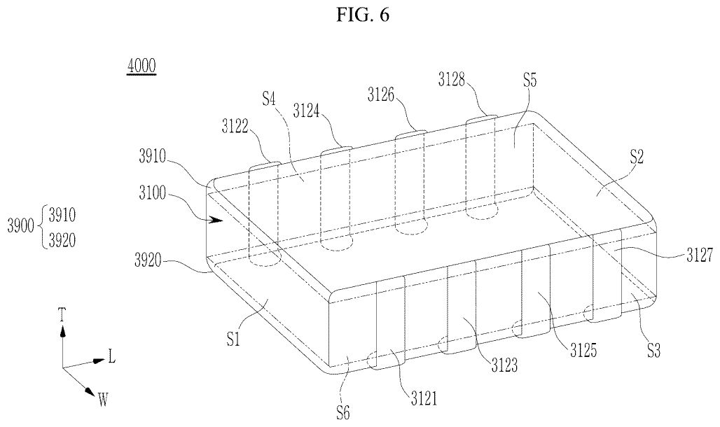

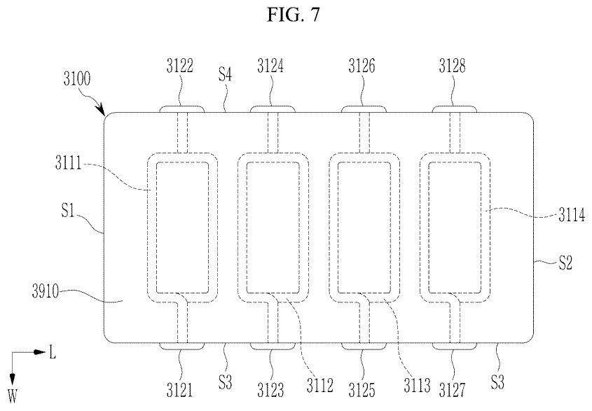

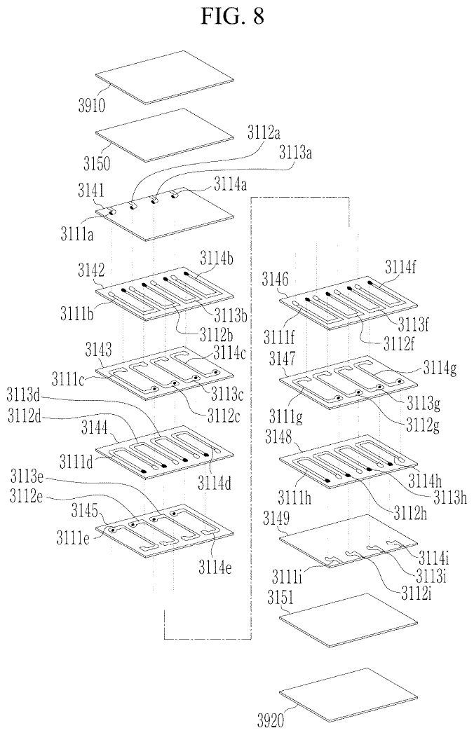

FIG. 6 is a perspective view schematically illustrating a coil electronic component according to still yet another embodiment, FIG. 7 is a plan view of FIG. 6, and FIG. 8 is an exploded perspective view illustrating a body of the coil electronic component of FIG. 6.

Referring to FIGS. 6 and 7, the coil electronic component 4000 includes a body 3100, first to eighth external electrodes 3121, 3122, 3123, 3124, 3125, 3126, 3127, and 3128 disposed on an outer surface of the body 3100, and a surface insulating layer 3900.

A first coil 3111, a second coil 3112, a third coil 3113, and a fourth coil 3114 are embedded in the body 3100. The respective winding axes of the first coil 3111, the second coil 3112, the third coil 3113, and the fourth coil 3114 may be parallel to the thickness direction (T-axis direction) of the body 3100.

The surface insulating layer 3900 is disposed on the fifth surface S5 and the sixth surface S6 of the body 3100.

The surface insulating layer 3900 includes a first insulating layer 3910 and a second insulating layer 3920. The first insulating layer 3910 is disposed on the fifth surface S5 of the body 3100, and the second insulating layer 3920 is disposed on the sixth surface S6 of the body 3100.

A sum of a thickness of the first insulating layer 3910 and a thickness of the second insulating layer 3920 may be 90 μm or more and 120 μm or less.

Referring to FIG. 8, the body 3100 may be a laminate made by stacking a plurality of magnetic sheets 3141, 3142, 3143, 3144, 3145, 3146, 3147, 3148, and 3149 on which conductive patterns 3111a to 3111i, 3112a to 3112i, 3113a to 3113i, and 3114a to 3114i comprising portions of the first to fourth coils 3111, 3112, 3113, and 3114 are disposed and a plurality of magnetic sheets 3150 and 3151 on which no conductive patterns are disposed in the thickness direction (T-axis direction).

A plurality of substantially J-shaped conductive patterns 3111a, 3112a, 3113a, and 3114a are formed on the magnetic sheet 3141. One end of each of the conductive patterns 3111a, 3112a, 3113a, and 3114a is drawn out from the edge of the magnetic sheet 3141 so as to be exposed from the fourth surface S4 of the body 3100.

A plurality of conductive patterns 3111b, 3112b, 3113b, and 3114b electrically connected to the respective conductive patterns 3111a, 3112a, 3113a, and 3114a are formed on the magnetic sheet 3142. The conductive patterns 3111b, 3112b, 3113b, and 3114b correspond to nearly ¾ of a turn of the first to fourth coils 3111, 3112, 3113, and 3114, and are in a substantially U-shape.

A plurality of conductive patterns 3111c, 3112c, 3113c, and 3114c electrically connected to the respective conductive patterns 3111b, 3112b, 3113b, and 3114b are formed on the magnetic sheet 3143. The conductive patterns 3111c, 3112c, 3113c, and 3114c correspond to nearly ¾ of a turn of the first to fourth coils 3111, 3112, 3113, and 3114, and are in a substantially C-shape.

A plurality of conductive patterns 3111d, 3112d, 3113d, and 3114d electrically connected to the respective conductive patterns 3111c, 3112c, 3113c, and 3114c are formed on the magnetic sheet 3144. The conductive patterns 3111d, 3112d, 3113d, and 3114d correspond to nearly ¾ of a turn of the first to fourth coils 3111, 3112, 3113, and 3114, and are in a substantially U-shape.

A plurality of conductive patterns 3111e, 3112e, 3113e, and 3114e electrically connected to the respective conductive patterns 3111d, 3112d, 3113d, and 3114d are formed on the magnetic sheet 3145. The conductive patterns 3111e, 3112e, 3113e, and 3114e correspond to nearly ¾ of a turn of the first to fourth coils 3111, 3112, 3113, and 3114, and are in a substantially C-shape.

A plurality of conductive patterns 3111f, 3112f, 3113f, and 3114f electrically connected to the respective conductive patterns 3111e, 3112e, 3113e, and 3114e are formed on the magnetic sheet 3146. The conductive patterns 3111f, 3112f, 3113f, and 3114f have the same structure as the conductive patterns 3111b, 3112b, 3113b, and 3114b described above.

A plurality of conductive patterns 3111g, 3112g, 3113g, and 3114g electrically connected to the respective conductive patterns 3111f, 3112f, 3113f, and 3114f are formed on the magnetic sheet 3147. The conductive patterns 3111g, 3112g, 3113g, and 3114g have the same structure as the conductive patterns 3111c, 3112c, 3113c, and 3114c described above.

A plurality of conductive patterns 3111h, 3112h, 3113h, and 3114h electrically connected to the respective conductive patterns 3111g, 3112g, 3113g, and 3114g are formed on the magnetic sheet 3148. The conductive patterns 3111h, 3112h, 3113h, and 3114h have the same structure as the conductive patterns 3111d, 3112d, 3113d, and 3114d described above.

A plurality of substantially J-shaped conductive patterns 3111i, 3112i, 3113i, and 3114i electrically connected to the respective conductive patterns 3111h, 3112h, 3113h, and 3114h are formed on the magnetic sheet 3149. One end of each of the conductive patterns 3111i, 3112i, 3113i, and 3114i is drawn out from the edge of the magnetic sheet 3149 so as to be exposed from the third surface S3 of the body 3100. In addition, electrical connections between conductive patterns on different magnetic sheets are made via through-holes (not shown) formed in the magnetic sheet.

The magnetic sheet 3150 on which no conductive pattern is disposed is stacked on the magnetic sheet 3141. The magnetic sheet 3150 protects the conductive patterns 3111a, 3112a, 3113a, and 3114a on the magnetic sheet 3141. In addition, another magnetic sheet 3151 on which no conductive pattern is disposed is disposed under the magnetic sheet 3149.

The number of magnetic sheets described above is by way of example only, and the present embodiment is not limited thereto.

The first insulating layer 3910 is disposed on the magnetic sheet 3150, and the second insulating layer 3920 is disposed below the magnetic sheet 3151.

A sum of a thickness of the first insulating layer 3910 and a thickness of the second insulating layer 3920 may be 90 μm or more or 120 μm or less.

The remaining components except the above are the same as the components of the coil electronic components shown in FIG. 1, so a repeated description thereof will be omitted.

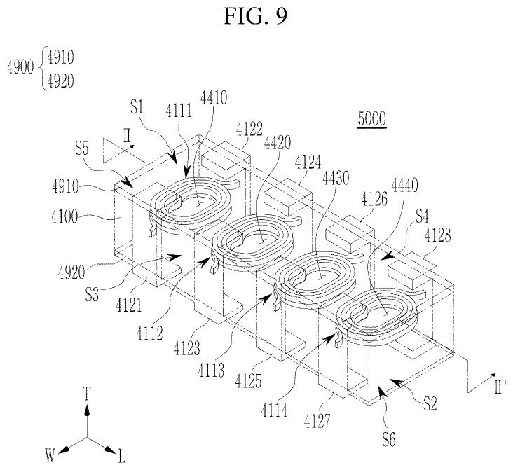

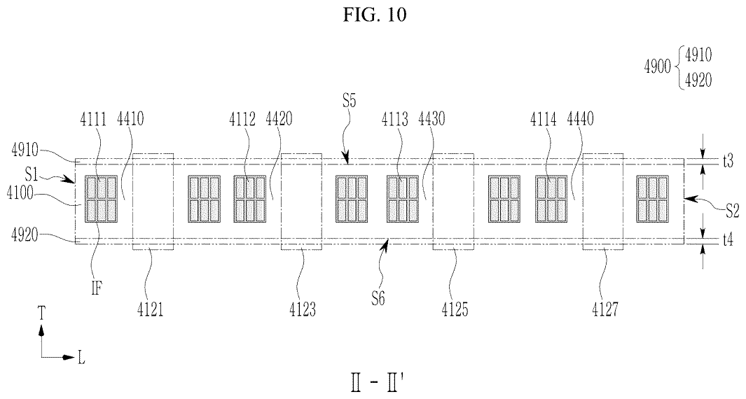

FIG. 9 is a perspective view schematically illustrating a coil electronic component according to another embodiment, and FIG. 10 is a schematic cross-sectional view taken along line II-II′ of FIG. 9.

Referring to FIGS. 9 and 10, a coil electronic component 5000 includes a body 4100, first to eighth external electrodes 4100, 4121, 4122, 4123, 4124, 4125, 4126, 4127, and 4128 disposed on an outer surface of the body 4100, and a surface insulating layer 4900

A first coil 4111, a second coil 4112, a third coil 4113, and a fourth coil 4114 are embedded in the body 4100. The body 4100 may include a first core 4410 penetrating the first coil 4111, a second core 4420 penetrating the second coil 4112, a third core 4430 penetrating the third coil 4413, and a fourth core 4440 penetrating the fourth coil 4414.

The first coil 4111 includes at least one turn of a conductive wire. The insulating film IF may be disposed on a surface of the first coil 4111.

The second coil 4112, the third coil 4113, and the fourth coil 4114 differ from the first coil 4111 only in their locations, so redundant descriptions thereof will be omitted.

A surface insulating layer 4900 is disposed on the fifth surface S5 and the sixth surface S6 of the body 4100.

The surface insulating layer 4900 includes a first insulating layer 4910 and a second insulating layer 4920. The first insulating layer 4910 is disposed on the fifth surface S5 of the body 4100, and the second insulating layer 4920 is disposed on the sixth surface S6 of the body 4100.

A sum of a thickness t3 of the first insulating layer 4910 and a thickness t4 of the second insulating layer 4920 may be 90 μm or more and 120 μm or less.

The remaining components except the above are the same as the components of the coil electronic components shown in FIG. 1, so a repeated description thereof will be omitted.

### Manufacturing Example: Manufacture of Coil Electronic Component

### Example 1

A coil electronic component was manufactured with a body having a magnetic permeability of 12 H/m and four coils spaced apart and embedded in the body, and an upper insulating layer and a lower insulating layer each having a magnetic permeability of 24 H/m were disposed on a top surface and a bottom surface of the body, and a sum of a thickness of the upper insulating layer and a thickness of the lower insulating layer was 90 μm.

### Example 2

Example 2 was the same as Example 1 except that the sum of the thickness of the upper insulating layer and the thickness of the lower insulating layer was 100 μm.

### Example 3

Example 3 was the same as Example 1 except that the sum of the thickness of the upper insulating layer and the thickness of the lower insulating layer was 110 μm.

### Example 4

Example 4 was the same as Example 1 except that the sum of the thickness of the upper insulating layer and the thickness of the lower insulating layer was 120 μm.

### Comparative Example 1

Comparative Example 1 was the same as Example 1 except that the sum of the thickness of the upper insulating layer and the thickness of the lower insulating layer was 80 μm.

### Comparative Example 2

Comparative Example 2 was the same as Example 1 except that the sum of the thickness of the upper insulating layer and the thickness of the lower insulating layer was 130 μm.

### Experimental Example: Performance of Coil Electronic Component

### (Insulation Resistance)

Fifty (50) pieces of each of coil electronic components according to Example 1-4 and Comparative Example 1-2 were manufactured, and then mounted on a substrate, and left for 72 hours under the conditions of 125° C., 1.2 atm, 95% RH (relative humidity), and rated voltage application to examine the change in insulation resistance of the coil electronic components. In addition, those that showed a decrease in insulation resistance compared to an initial value were deemed defective. The results are summarized in Table 1.

TABLE 1

| | Rate of defective insulation |
|---|---|
| | resistance (%) |
| Comparative Example 1 | 1.40 |
| Example 1 | 0.00 |
| Example 2 | 0.00 |
| Example 3 | 0.00 |
| Example 4 | 0.00 |
| Comparative Example 2 | 0.00 |

Referring to Table 1, the rate of defective insulation resistance of the coil electronic component according to Example 1-4 and Comparative Example 2 was 0.00%. On the contrary, the rate of defective insulation resistance of the coil electronic component according to Comparative Example 1 was 1.40%. This appears to be because the sum of the thickness of the upper insulating layer and the thickness of the lower insulating layer of the coil electronic component according to Comparative Example 1 was relatively small (80 μm), so that sufficient insulation resistance could not be secured.

### (Increase Rate of Inductance)

Fifty (50) pieces of each of coil electronic components according to Example 1-4 and Comparative Example 1-2 were manufactured, and then the self-inductances of the first coil, the second coil, the third coil, and the fourth coil were measured, and the increase rates of the inductances were measured based on a reference value (Ref.), and the results are summarized in Table 2.

The increase rate of inductance was calculated as follows.

With reference to the self-inductances of the first coil, the second coil, the third coil, and the fourth coil of a coil electronic component in which the magnetic permeability of the body was 12 H/m, and no upper insulating layer and lower insulating layer were disposed on the top and the bottom of the body, a rate of increase in self-inductance of each coil of the coil electronic component according to Example 1-4 and Comparative Example 1-2 was calculated. If the increase rate of inductance was less than 1%, it was deemed suitable, and if the increase rate of inductance was equal to or greater than 1%, it was deemed unsuitable. The reason is that when the increase rate of inductance is equal to or greater than 1%, differences in coefficient of coupling between the coils increase, which may cause performance degradation.

TABLE 2

| | | first coil | second coil | third coil | fourth coil | |
|---|---|---|---|---|---|---|
| Reference value | Inductance (nH) | 7.196 | 7.592 | 7.517 | 7.401 | — |
| (Ref.) | | | | | | |
| Comparative | Inductance (nH) | 7.224 | 7.603 | 7.534 | 7.412 | Suitable |
| Example 1 | Increase rate of | 0.38% | 0.14% | 0.23% | 0.15% | |
| | Inductance (%) | | | | | |
| Example 1 | Inductance (nH) | 7.234 | 7.611 | 7.543 | 7.421 | Suitable |
| | Increase rate of | 0.52% | 0.25% | 0.34% | 0.27% | |
| | Inductance (%) | | | | | |
| Example 2 | Inductance (nH) | 7.244 | 7.619 | 7.552 | 7.430 | Suitable |
| | Increase rate of | 0.67% | 0.36% | 0.46% | 0.40% | |
| | Inductance (%) | | | | | |
| Example 3 | Inductance (nH) | 7.254 | 7.627 | 7.560 | 7.439 | Suitable |
| | Increase rate of | 0.81% | 0.46% | 0.58% | 0.52% | |
| | Inductance (%) | | | | | |
| Example 4 | Inductance (nH) | 7.264 | 7.635 | 7.569 | 7.448 | Suitable |
| | Increase rate of | 0.95% | 0.57% | 0.69% | 0.64% | |
| | Inductance (%) | | | | | |
| Comparative | Inductance (nH) | 7.346 | 7.736 | 7.663 | 7.542 | Unsuitable |
| Example 2 | Increase rate of | 2.09% | 1.89% | 1.95% | 1.91% | |
| | Inductance (%) | | | | | |

Referring to Table 2, the increase rate of inductance of the coil electronic component according to Example 1-4 and Comparative Example 1 was less than 1%. On the contrary, the increase rate of inductance of the coil electronic component according to Comparative Example 2 was greater than 1%. This appears to be because the sum of the thickness of the upper insulating layer and the thickness of the lower insulating layer was relatively large (130 μm) in the coil electronic component according to Comparative Example 2 and therefore the magnetic permeabilities the upper and lower insulating layers were large compared to that of the body, so that the increase rate of inductance became excessively high.

### (Switching Frequency)

Fifty (50) pieces of each coil electronic components according to Example 1-4 and Comparative Example 1-2 were manufactured, and the switching frequency was measured, and the results are summarized in Table 3.

When the switching frequency was larger than 90 MHz, it was deemed suitable, and when the switching frequency was equal to or smaller than 90 MHz, it was deemed unsuitable.

TABLE 3

| | Switching frequency | |
|---|---|---|
| | (MHz) | |
| Comparative Example 1 | 103 | Suitable |
| Example 1 | 100 | Suitable |
| Example 2 | 97 | Suitable |
| Example 3 | 95 | Suitable |
| Example 4 | 92 | Suitable |
| Comparative Example 2 | 82 | Unsuitable |

Referring to Table 3, the switching frequency of the coil electronic component according to Example 1-4 and Comparative Example 1 was larger than 90 MHz. On the contrary, the switching frequency of the coil electronic component according to Comparative Example 2 was 82 MHz. This appears to be because the sum of the thickness of the upper insulating layer and the thickness of the lower insulating layer was relatively large (130 μm) in the coil electronic component according to Comparative Example 2, which means an insulating layer with a large magnetic permeability includes large particles, so that eddy current loss increased and the switching frequency was lowered.

Although the embodiment of the present disclosure is described hereinabove, the present disclosure is not limited thereto, and various modifications can be made within the scopes of the claims, and the description of the present disclosure and the accompanying drawings, and belongs to the scope of the present disclosure, of course.

What is claimed is:

1. A coil electronic component comprising:
a body including a first surface and a second surface opposing each other in a first direction, a third surface and a fourth surface opposing each other in a second direction and connecting the first surface and the second surface, and a fifth surface and a sixth surface opposing each other in a third direction and connecting the first surface and the second surface, and including a magnetic material;
three or more coils embedded in the body; and
a first insulating layer and a second insulating layer disposed on the first surface and the second surface of the body, respectively, or on the fifth surface and the sixth surface of the body, respectively,
wherein a sum of a thickness of the first insulating layer and a thickness of the second insulating layer is 90 μm or more and 120 μm or less.

2. The coil electronic component of claim 1, wherein
the first insulating layer and the second insulating layer each includes a magnetic material.

3. The coil electronic component of claim 2, wherein
the magnetic material included in the first insulating layer and the magnetic material included in the second insulating layer are different from the magnetic material included in the body.

4. The coil electronic component of claim 2, wherein
a magnetic permeability of the first insulating layer is larger than a magnetic permeability of the body, and
a magnetic permeability of the second insulating layer is larger than the magnetic permeability of the body.

5. The coil electronic component of claim 1, further comprising:
a first support member, a second support member, and a third support member that are embedded in the body and spaced apart from each other,
wherein the coils include a first coil, a second coil, and a third coil that are spaced apart from each other,
the first coil is disposed on the first support member,
the second coil is disposed on the second support member, and
the third coil is disposed on the third support member.

6. The coil electronic component of claim 5, wherein
a winding axis of each of the first coil, the second coil, and the third coil is parallel to the third direction,
the first insulating layer is disposed on the fifth surface of the body, and
the second insulating layer is disposed on the sixth surface of the body.

7. The coil electronic component of claim 5, wherein
a winding axis of each of the first coil, the second coil, and the third coil is parallel to the first direction,
the first insulating layer is disposed on the fifth surface of the body, and
the second insulating layer is disposed on the sixth surface of the body.

8. The coil electronic component of claim 5, wherein
a winding axis of each of the first coil, the second coil, and the third coil is parallel to the first direction,
the first insulating layer is disposed on the first surface of the body, and
the second insulating layer is disposed on the second surface of the body.

9. The coil electronic component of claim 5, wherein
the first coil includes two coil patterns disposed on one surface and the other surface of the first support member, respectively, and connected to each other through a via penetrating the first support member,
the second coil includes two coil patterns disposed on one surface and the other surface of the second support member, respectively, and connected to each other through a via penetrating the second support member, and
the third coil includes two coil patterns disposed on one surface and the other surface of the second support member, respectively, and connected to each other through a via penetrating the third support member.

10. The coil electronic component of claim 1, wherein
the body is a laminate in which a plurality of magnetic sheets is stacked,
the coils include a first coil, a second coil, and a third coil that are spaced apart from each other, and
each of the first coil, the second coil, and the third coil includes a plurality of conductive patterns disposed on each magnetic sheet of the plurality of magnetic sheets and connected to each other.

11. The coil electronic component of claim 1, wherein
the coils include a first coil, a second coil, and a third coil that are spaced apart from each other, and
each of the first coil, the second coil, and the third coil includes at least one turn of a conductive wire.

12. The coil electronic component of claim 11, wherein
the body includes a first core penetrating the first coil, a second core penetrating the second coil, and a third core penetrating the third coil.

13. The coil electronic component of claim 11, wherein
an insulating film is disposed on the surface of the conductive wire.

14. The coil electronic component of claim 1, further comprising:
three or more pairs of external electrodes connected to the three or more coils, respectively,
wherein each of the three or more pairs of external electrodes includes one external electrode disposed on the third surface and another external electrode disposed on the fourth surface.

15. The coil electronic component of claim 14, wherein
the first insulating layer and the second insulating layer are disposed only on surfaces selected from the first, second, fifth, and sixth surfaces among the first to sixth surfaces of the body.

16. The coil electronic component of claim 15, wherein
the first insulating layer and the second insulating layer are disposed only on the first surface and the second surface of the body, respectively, or only on the fifth surface and the sixth surface of the body, respectively.
